(19) United States
(12) Patent Application Publication
(10) Pub. No.: US 2026/0279399 A1
(43) Pub. Date: Sep. 17, 2026

(54) VIDEO SEEK DISPLAY PROCESSING METHOD AND APPARATUS

(71) Applicant: Beijing Zitiao Network Technology Co., Ltd., Beijing (CN)

(72) Inventor: Kailu QIU, Beijing (CN)

(21) Appl. No.: 19/168,799

(22) PCT Filed: May 17, 2024
(86) PCT No.: PCT/CN2024/094065

§ 371 Date: Sep. 24, 2025

(30) Foreign Application Priority Data
May 18, 2023 (CN) 202310564980.7

(51) Int. Cl. G11B 27/00; G11B 27/10; G11B 27/34; H04N 19/172; H04N 19/177; H04N 19/423

(52) U.S. Cl. CPC G11B 27/005; G11B 27/102; G11B 27/34; H04N 19/172; H04N 19/177; H04N 19/423

(57) ABSTRACT

The present disclosure relates to a video seek display processing method and apparatus. The method includes: obtaining a seek request for a video; matching a timeline position indicated by the seek request with a timeline position of individual decoded video frames in a cache queue to obtain a matching result; and if a seek direction indicates a forward seek and the matching result indicates that the seek request results in a cache queue miss, or the seek direction indicates a backward seek, the matching result indicates that the seek request results in a cache queue miss, and a video frame at the timeline position indicated by the seek request and the video frames in the cache queue do not belong to a same group of pictures, performing a seek operation, and skip performing a seek operation in other scenarios.

### CROSS-REFERENCE TO RELATED APPLICATION(S)

The present application claims priority to Chinese Patent Application No. 202310564980.7, filed on May 18, 2023, and entitled “VIDEO SEEK DISPLAY PROCESSING METHOD AND APPARATUS”, which is incorporated herein by reference in its entirety.

### FIELD

The present disclosure relates to the field of video processing technologies, and in particular, to a video seek display processing method and apparatus.

### BACKGROUND

When using a video-related application, a user often performs video playback or video frame preview, during which the user may trigger a seek request. For example, when editing a video using a video editing application, the user often previews an editing effect by seeking. The application provides an edit track. The user may add a video track clip to be edited to the edit track. The user may trigger a seek request through a timeline to seek to a video frame at a specified timeline position. A plurality of video track clips may be imported onto the edit track, or even the plurality of video track clips overlap on the timeline. To seek to a position where the plurality of video track clips overlap, it is necessary to obtain pictures of the plurality of video frames, and render and composite the pictures for display on a screen.

In the related art, in response to the seek request, the application queries a cache queue first. If the seek request results in a cache queue miss, the application clears existing cache data in response to the seek request, and invokes a relevant application programming interface (API) to control a decoder to perform decoding from a corresponding reference frame based on a specified timeline position requested by the seek request to obtain a decoded video frame at the specified time position, and render the video frame for display on the screen. It takes a long time for the application to return the decoded video frame in the above-mentioned manner. In some scenarios, pictures of video frames need to be quickly switched for display and such a long time causes a video picture lag phenomenon, resulting in poor user experience.

### SUMMARY

In order to solve the technical problem described above, the present disclosure provides a video seek display processing method and apparatus.

According to a first aspect, the present disclosure provides a video seek display processing method, including:
obtaining a seek request triggered on a timeline for video preview, where the seek request is configured to request a seek from a first timeline position to a second timeline position;
performing matching based on the second timeline position and individual decoded video frames in a cache queue to obtain a matching result;
clearing the cache queue, controlling a decoder to perform decoding based on the second timeline position, and storing a decoded video frame into the cache queue, if a first condition or a second condition is met, or skipping clearing the cache queue if a third condition or a fourth condition is met, where the first condition is that the seek request indicates a forward seek and the matching result indicates that the cache queue does not include a video frame at the second timeline position, the second condition is that a seek direction indicates a backward seek, the matching result indicates that the cache queue does not include the video frame at the second timeline position, and the video frame at the second timeline position and the cache queue do not belong to a same group of pictures, the third condition is that the cache queue includes the video frame at the second timeline position, and the fourth condition is that the seek direction indicates a backward seek, the matching result indicates that the cache queue does not include the video frame at the second timeline position, and the video frame at the second timeline position and the cache queue belong to a same group of pictures; and
reading, based on the met condition and a seek mode corresponding to the seek request, the video frame at the second timeline position or any video frame within a tolerance range for the second timeline position from the cache queue, and rendering and displaying the read video frame.

In some embodiments, reading from the cache queue, based on the met condition and the seek mode indicated by the seek request, the video frame at the second timeline position or any video frame within the tolerance range for the second timeline position, and rendering and displaying the read video frame includes:
reading the video frame at the second timeline position from the cache queue, and rendering and displaying the read video frame, if the first condition or the second condition is met and the seek mode is a precise mode;
reading any video frame within the tolerance range for the second timeline position from the cache queue, and rendering and displaying the read video frame, if the first condition or the second condition is met and the seek mode is an imprecise mode; or
reading the video frame at the second timeline position from the cache queue, and rendering and displaying the read video frame, if the third condition or the fourth condition is met.

In some embodiments, before reading any video frame within the tolerance range for the second timeline position from the cache queue, and rendering and displaying the read video frame, the method further includes:
calculating the tolerance range for the second timeline position.

In some embodiments, calculating the tolerance range for the second timeline position includes:
calculating a first time difference based on the second timeline position and a third timeline position, where the third timeline position is a timeline position of a video frame that is displayed by a previous seek request; and
determining, in the seek direction, a time range that starts from the second timeline position and that has a distance from the second timeline position on the timeline meeting the first time difference as the tolerance range.

In some embodiments, controlling the decoder to perform decoding based on the second timeline position includes:
controlling the decoder to discard, during the decoding, non-reference frames preceding the tolerance range on the timeline if the seek direction indicates a forward seek.

In some embodiments, the method further includes:
calculating a target time threshold based on a maximum quantity of video frames that can be cached forward in the cache queue and playback duration of a single video frame;
calculating a second time difference based on a timeline position of the video frame output by the decoder and a timeline position of the video frame read in response to the seek request; and
comparing the second time difference with the target time threshold to obtain a comparison result, and writing the video frame output by the decoder to the cache queue or discarding the video frame output by the decoder based on the comparison result.

In some embodiments, the method further includes: reading the first video frame in the cache queue, and rendering and displaying the read first video frame if it is determined, based on a quantity of the decoded video frames, a maximum range of reference frames, the second timeline position, a presentation time stamp of the first video frame in the cache queue, and frame duration of a single video frame, that the video frame at the second timeline position cannot be successfully obtained.

According to a second aspect, the present disclosure provides a video seek display processing apparatus, including:
an obtaining module configured to obtain a seek request triggered on a timeline for video preview, where the seek request is configured to request a seek from a first timeline position to a second timeline position;
a matching module configured to perform matching based on the second timeline position and individual decoded video frames in a cache queue to obtain a matching result;
a processing module configured to clear the cache queue, control a decoder to perform decoding based on the second timeline position, and store a decoded video frame into the cache queue, if a first condition or a second condition is met, or skip clearing the cache queue if a third condition or a fourth condition is met, where the first condition is that the seek request indicates a forward seek and the matching result indicates that the cache queue does not include a video frame at the second timeline position, the second condition is that a seek direction indicates a backward seek, the matching result indicates that the cache queue does not include the video frame at the second timeline position, and the video frame at the second timeline position and the cache queue do not belong to a same group of pictures, the third condition is that the cache queue includes the video frame at the second timeline position, and the fourth condition is that the seek direction indicates a backward seek, the matching result indicates that the cache queue does not include the video frame at the second timeline position, and the video frame at the second timeline position and the cache queue belong to a same group of pictures; and read from the cache queue, based on the met condition and a seek mode corresponding to the seek request, the video frame at the second timeline position or any video frame within a tolerance range for the second timeline position, and render and display the read video frame; and
a display module configured to display a corresponding video frame.

According to a third aspect, the present disclosure provides an electronic device, including a memory and a processor, where
the memory is configured to store computer program instructions; and
the processor is configured to execute the computer program instructions to cause the electronic device to implement the video seek display processing of the first aspect.

According to a fourth aspect, the present disclosure provides a readable storage medium, including computer program instructions, where at least one processor of an electronic device, when executing the computer program instructions, causes the electronic device to implement the video seek display processing method of the first aspect.

According to a fifth aspect, the present disclosure provides a program product, where the computer program product, when run on an electronic device, causes the electronic device to implement the video seek display processing method of the first aspect.

Embodiments of the present disclosure provide a video seek display processing method and apparatus. The method includes: obtaining a seek request for a video; matching a timeline position indicated by the seek request with a timeline position of an individual decoded video frame in a cache queue to obtain a matching result; and if a seek direction indicates a forward seek and the matching result indicates that the seek request results in a cache queue miss, or the seek direction indicates a backward seek, the matching result indicates that the seek request results in a cache queue miss, and a video frame at the timeline position indicated by the seek request and the video frames in the cache queue do not belong to a same group of pictures, performing a seek operation, and skip performing a seek operation in other scenarios. According to the present disclosure, a scenario in which a seek operation needs to be truly performed is perceived by means of a cache queue, thereby improving the rationality and necessity of performing a seek operation, then increasing the speed of response to a seek request, reducing a video picture lag phenomenon, and improving the user experience.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a schematic diagram of a framework of an application according to the present disclosure;

FIG. 2 is a flowchart of a video seek display processing method according to an embodiment of the present disclosure;

FIG. 3 is a schematic diagram of a relationship between a cache queue and a timeline according to an embodiment of the present disclosure;

FIG. 4 is a schematic diagram of a scenario in which an application responds to a seek request in a conventional manner;

FIG. 5 is an exemplary schematic diagram of a scenario of responding to a seek request based on a tolerance range according to the present disclosure;

FIG. 6 is a schematic diagram of a frame discarding strategy according to an embodiment of the present disclosure;

FIG. 7 is a flowchart of a video seek display processing method according to an embodiment of the present disclosure;

FIG. 8 is a schematic diagram of a relationship between a target time threshold and a cache queue according to the present disclosure;

FIG. 9 is a flowchart of a video seek display processing method according to an embodiment of the present disclosure; and

FIG. 10 is a structural diagram of a video seek display processing apparatus according to the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

### Definitions of Related Terms

Seek: During preview of a video, a process of navigating from a video frame at a timeline position to a video frame at another timeline position is referred to as a seek. A seek in the present disclosure may also be understood as a seek request.

Group of Pictures (GOP): A group of pictures is a group of continuous pictures, and the first picture of a GOP needs to be an I-frame, so that it can be ensured that the GOP can be decoded independently without reference to other pictures. Pictures are classified into I, P, and B in MPEG coding. I is an intra-coded frame, P is a forward predicted frame, and B is a bidirectionally interpolated frame. That is, the I-frame is a key frame, which may be understood as a complete video frame, and the P-frame and the B-frame record changes with respect to the I-frame. The P-frame represents differences from a prior frame, the B-frame represents differences between past and future frames, and the I-frame serves as the reference frame for decoding subsequent P-frames and B-frames. Without the I-frame, P-frames and B-frames are undecodable. The length of the GOP is the distance between two adjacent I-frames. Assuming that a sequence of video frames is as follows: I, P, B, B, B, I, P, B, B, B. The length of the GOP is 5, i.e., the GOP contains five video frames.

For ease of description, an operation of clearing existing cache and invoking a relevant API to control a decoder to perform decoding, based on a specified timeline position indicated by a seek request, from a reference frame corresponding to the specified timeline position is referred to as a seek operation.

In a conventional manner, an application performs one seek operation when a seek request results in a cache queue miss. However, in some scenarios, if the conventional manner is used to achieve quick switching and display of video pictures, the application performs a lot of unnecessary computation, which consumes a long time and causes severe video picture lagging, resulting in poor user experience. For example, when a seek request indicates a backward seek and the seek request results in a cache miss, decoded video frames included in the cache queue belong to a same GOP as the video frame at a specified timeline position indicated by the seek request, and one seek operation is performed if the conventional manner is used. In the conventional manner, the video frames in the range from the I-frame backward to the last video frame of the cache queue along the timeline are decoded repeatedly, and the computation consumes a long time, resulting in severe video picture lagging.

In summary, analy zing the rationality and necessity of performing a seek operation and executing the seek operation in the most necessary scenario are of great significance to improving the processing efficiency of video picture switching and display and solving the video picture lagging problem.

Based on this, the present disclosure provides a video seek display processing method and apparatus. In the method, a scenario in which a seek operation needs to be truly performed is perceived by means of a cache queue, thereby improving the rationality and necessity of performing a seek operation, then increasing the speed of response of an application to a seek request, reducing a video picture lag phenomenon, and improving the user experience.

For example, the video seek display processing method provided in the present disclosure is performed by an electronic device. The electronic device may be a tablet computer, a mobile phone (e.g., a foldable phone and a large-screen phone), a wearable device, an in-vehicle device, an augmented reality (AR) device/a virtual reality (VR) device, a notebook computer, an ultra-mobile personal computer (UMPC), a netbook, a personal digital assistant (PDA), a smart television, a smart screen, a high-definition television, a 4K television, a smart speaker, a smart projector or another Internet of Things (IOT) device. The present disclosure is not limited to the specific type of the electronic device.

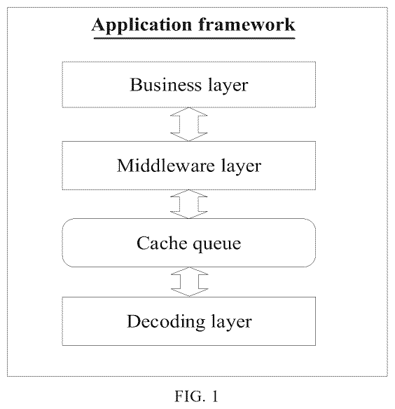

FIG. 1 is a schematic diagram of a framework of an application according to the present disclosure. Referring to FIG. 1, the application includes a business layer, a middleware layer, and a decoding layer. The application may be, but is not limited to, a video playback application, or a video editing application. In the present disclosure, the business layer is mainly configured to obtain a seek request triggered on a timeline for video preview, pass the seek request to the middleware layer, obtain a decoded video frame returned by the middleware layer in response to the seek request, and render and display the decoded video frame, etc. The middleware layer is mainly configured to determine, based on information such as a specified timeline position indicated by the seek request, a timeline position of a decoded video frame in a cache queue, and a seek direction, whether a seek operation needs to be performed, and invoke a relevant API to perform the seek operation if a seek operation is determined to be performed. The decoding layer is mainly configured to decode video frames in a decoding queue in response to an instruction from the middleware layer.

In the following embodiments, the method provided in the present disclosure is described in detail by using an example in which an electronic device is used, a video-related application is installed on the electronic device, and the framework shown in FIG. 1 is used for the application.

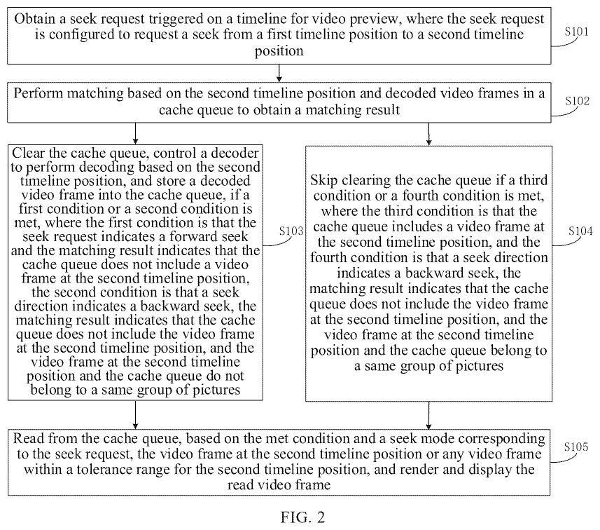

FIG. 2 is a flowchart of a video seek display processing method according to an embodiment of the present disclosure. Referring to FIG. 2, the method in this embodiment may include the following steps.
S101: Obtain a seek request triggered on a timeline for video preview, where the seek request is configured to request a seek from a first timeline position to a second timeline position.

A business layer of an application may display an interactive interface on a display screen of an electronic device. A user operates, by touching the electronic device or by operating an external device (e.g., a mouse) connected to the electronic device, a timeline (e.g., a video playback timeline, or a preview timeline) displayed on the interactive interface to trigger the seek request. The business layer of the application determines the second timeline position, a seek mode, or other information based on the operation of the user on the timeline, and generates the seek request based on the determined information. The seek mode is described in detail below.

It should be noted that the present disclosure is not limited to the manner in which the user triggers a video seek. In addition to the manner of the above-mentioned example, the user may trigger a seek request via a full-screen drag function, a material drag function, a thumbnail drag function, etc. provided by the application.

S102: Perform matching based on the second timeline position and individual decoded video frames in a cache queue to obtain a matching result.

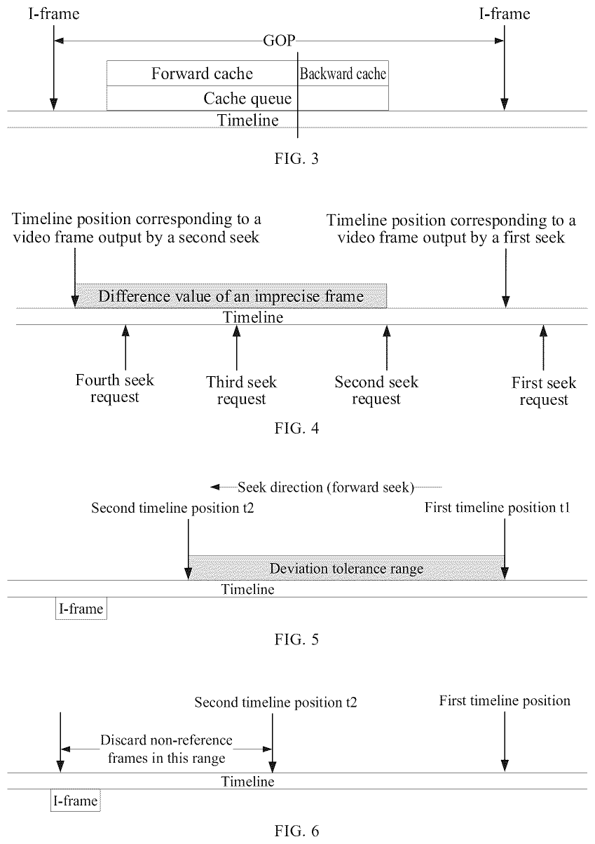

The cache queue is configured to cache decoded video frames output by a decoder. For example, referring to FIG. 3, with a video frame as a reference video frame, the position of the reference video frame on the timeline is shown by a black vertical line in FIG. 3. The cache queue may include a forward cache and a backward cache corresponding to the reference video frame. A timeline position of a video frame included in the forward cache is less than the timeline position of the reference video frame, and a timeline position of a video frame included in the backward cache is greater than the timeline position of the reference video frame. The forward cache and the backward cache may meet preset ratio relationships, e.g., the forward cache accounts for 0.7 of the cache queue, and the backward cache accounts for 0.3 of the cache queue.

In the present disclosure, a middleware layer of the application internally perceives and determines whether the seek operation needs to be performed. This eliminates the dependence on the business layer in a conventional manner. The module in the middleware layer that can quickly and accurately perceive whether a seek operation needs to be performed is the cache queue. Therefore, when receiving the seek request, the middleware layer of the application queries the cache queue based on the second timeline position indicated by the seek request to obtain a matching result.

The purpose of querying the cache queue is to obtain information on two aspects. 1. Whether the seek request results in a cache queue hit, i.e., whether the cache queue includes a video frame at the second timeline position. 2. Whether the video frame at the second timeline position and the individual decoded video frames in the cache queue belong to a same group of pictures.

The cache queue may determine, by comparing the second timeline position with a timeline position of the first video frame in the cache queue and comparing the second timeline position with a timeline position of the last video frame in the cache queue, whether the seek request results in a hit in the cache queue. In the case of a hit, it can be simultaneously determined whether the video frame at the second timeline position and the individual decoded video frames in the cache queue belong to the same GOP. In the case of a miss, the timeline position of a corresponding I-frame and the time interval of the I-frame are obtained, it is determined whether the second timeline position is greater than the timeline position of the I-frame and less than a timeline position of a next I-frame to determine whether the second timeline position belongs to the GOP, and it is determined whether the cache queue belongs to the GOP, thereby obtaining information in the second aspect described above.
S103: Clear the cache queue, control a decoder to perform decoding based on the second timeline position, and store a decoded video frame into the cache queue, if a first condition or a second condition is met, where the first condition is that the seek request indicates a forward seek and the matching result indicates that the cache queue does not include a video frame at the second timeline position, the second condition is that a seek direction indicates a backward seek, the matching result indicates that the cache queue does not include the video frame at the second timeline position, and the video frame at the second timeline position and the cache queue do not belong to a same group of pictures.
S104: Skip clearing the cache queue if a third condition or a fourth condition is met, where the third condition is that the cache queue includes a video frame at the second timeline position, and the fourth condition is that a seek direction indicates a backward seek, the matching result indicates that the cache queue does not include the video frame at the second timeline position, and the video frame at the second timeline position and the cache queue belong to a same group of pictures.

The middleware layer of the application determines, based on the seek direction indicated by the seek request passed by the business layer and the matching result fed back by the cache queue, whether a seek operation needs to be performed in a current scenario. Based on combinations of the seek direction and the matching result, the following scenarios may be included.
Scenario 1: The seek direction indicates a forward seek, the seek request results in a cache queue miss, a video frame of a first time stamp and individual decoded video frames in the cache queue belong to a same GOP.
Scenario 2: The seek direction indicates a forward seek, the seek request results in a cache queue miss, a video frame of a first time stamp and individual decoded video frames in the cache queue do not belong to a same GOP.
Scenario 3: The seek direction indicates a backward seek, the seek request results in a cache queue miss, a video frame of a first time stamp and individual decoded video frames in the cache queue do not belong to a same GOP.
Scenario 4: The seek direction indicates a backward seek, the seek request results in a cache queue miss, a video frame of a first time stamp and individual decoded video frames in the cache queue belong to a same GOP.
Scenario 5: The seek direction indicates a forward seek, and the seek request results in a cache queue hit.
Scenario 6: The seek direction indicates a backward seek, and the seek request results in a cache queue hit.

When determining that the current scenario is any of the above-mentioned scenario 1 to scenario 3, the middleware layer of the application determines that a seek operation needs to be performed. When determining that the current scenario is any of scenario 4 to scenario 6, the middleware layer determines that a seek operation does not need to be performed.

After determining that a seek operation needs to be performed, the middleware layer (the cache queue) sends the seek request and an indicator signal to a decoding layer. The indicator signal represents that the cache queue is currently in a frame deficiency state, and the indicator signal may further indicate a forward frame deficiency or a backward frame deficiency. The decoding layer determines a decoding start frame based on the second timeline indicated by the seek request and a frame deficiency direction, starts decoding processing from the decoding start frame, and writes a decoded video frame output by the decoder to the cache queue. The decoding start frame is usually the first video frame (an I-frame) of a GOP, which is the reference frame for decoding.
S105: Read from the cache queue, based on the met condition and a seek mode corresponding to the seek request, the video frame at the second timeline position or any video frame within a tolerance range for the second timeline position, and render and display the read video frame.

The middleware layer of the application may determine, based on the condition met by the seek request and the seek mode, that a video frame that needs to be returned is a precise frame or an imprecise frame, read a corresponding video frame from the cache queue, and send the corresponding video frame to the business layer, so that the business layer renders and displays the corresponding video frame, thereby successfully achieving picture seek display.

If the first condition or the second condition is met and the seek mode is a precise mode, the video frame at the second timeline position is read from the cache queue, and the read video frame is rendered and displayed. If the first condition or the second condition is met and the seek mode is an imprecise mode, any video frame within the tolerance range for the second timeline position is read from the cache queue, and the read video frame is rendered and displayed. If the third condition is met, the video frame at the second timeline position is directly read from the cache queue, and the read video frame is rendered and displayed. If the fourth condition is met, a current decoding task is not interrupted, and the decoder continues to decode video frames located after the last video frame of the cache queue backward successively along the timeline, and write the decoded data of the decoded video frame to the cache queue. Subsequently, the video frame at the second timeline position is read from the cache queue, and the read video frame is rendered and displayed.

In the method in this embodiment, a scenario in which a seek operation needs to be truly performed is perceived by means of a cache queue, thereby improving the rationality and necessity of performing a seek operation, then responding to a seek request in time to return a target video frame meeting the seek request for rendering and display, reducing a video picture lag phenomenon, and improving the user experience.

Next, how to read a video frame when the seek mode is the imprecise mode is described in detail.

In the present disclosure, the middleware layer of the application may provide two seek modes for the business layer to choose: 1. a precise seek mode; and 2. a sliding seek mode, i.e., an imprecise seek mode. The business layer may determine, based on a business scenario, which seek mode is to be used. For example, in a frame-by-frame seek scenario or a fixed-frame seek scenario, the precise seek mode needs to be used. If a preview axis function, a full-screen drag function, or a material drag function is used to trigger a seek, smoothness requirements of pictures are high, and the imprecise seek mode may be used.

After the business layer determines which seek mode is to be used based on the business scenario, mode indication information may be added to the seek request, such that the middleware layer can determine the seek mode, and then determine which frame on the timeline needs to be returned or which time range in which video frames need to be returned. It should be understood that if the seek mode is a precise seek mode, the video frame at the second timeline position needs to be returned, and video frames at other timeline positions cannot meet scenario requirements. If the seek mode is the imprecise seek mode, the returned video frame may deviate from the second timeline position, and the priority is to ensure the smoothness of video pictures.

A video frame returned in the imprecise seek mode may be understood as an imprecise frame. Since a backward seek may return any frame located after a currently displayed video frame, the smoothness of pictures of the backward seek can be ensured. However, in a scenario of a forward seek, whether the selection of an imprecise frame is appropriate severely affects seek performance. For example, referring to FIG. 4, assuming that a forward seek is performed four times along the timeline. A video frame returned by the first seek is located between a timeline position of the first seek and a timeline position of the second seek. A video frame returned by the second seek is located before a timeline position of the fourth seek. Since a strategy for selecting an imprecise frame is to select a video frame as close as possible, in order to prevent the picture from jumping back and forth, neither the third seek nor the fourth seek can return a video frame, and the video picture keeps displaying the video frame returned by the second seek. Therefore, in the scenario of the forward seek, how to select an imprecise frame is the focus of achieving an imprecise seek.

In order to improve the performance of an imprecise seek in a scenario of a forward seek, in the present disclosure, a tolerance range for the selection of the imprecise frame is determined based on the third timeline position specified by predicting a next seek request and the second timeline position. In a possible implementation, the calculation of the tolerance range may be implemented by the following steps.

Step a1: Calculate a first time difference based on the second timeline position and the third timeline position of the video frame displayed in response to the previous seek request. The formula may be expressed as: Δt=t1−t0, where Δt represents the first time difference, t1 represents the second timeline position, and to represents the third timeline position. It should be understood that the seek direction indicated by the previous seek request is a forward seek.

Step a2: Determine, in the seek direction indicated by the current seek request, a time range that starts from the second timeline position and that has a distance from the second timeline position on the timeline meeting the first time difference as the tolerance range. The formula may be expressed as: t2=Δt+t1, where t2 represents an end point of the tolerance range, and may be recorded as a fourth timeline position. It should be noted that the time range between t2 and t1 on the timeline is the tolerance range.

For example, assuming that the current seek request indicates a forward seek and positions of t2 and t1 on the timeline can be seen in FIG. 5, any video frame between t2 and t1 may be an imprecise frame.

As can be seen from comparing the embodiments shown in FIG. 4 and FIG. 5, when it is determined that a seek operation needs to be performed and it is determined that the seek mode is an imprecise seek mode, in the present disclosure, a corresponding tolerance range can be obtained by predicting a next seek request. The selection of an imprecise frame within the tolerance range can improve a seek hit rate, thereby avoiding a video picture from jumping back and forth.

It should be noted that an imprecise seek may alternatively be achieved in a manner of issuing the tolerance range by the business layer. Alternatively, the user may preconfigure the first time difference, so that the middleware layer determines the tolerance range based on the preconfigured first time difference. Certainly, the tolerance range may be determined in another manner. This is not limited to the manners in the above-mentioned examples.

An example shown in FIG. 5 is used. Usually, in a scenario of a forward seek, the decoder is triggered to perform decoding from an I-frame. Affected by a decoding sequence, decoded data of a video frame at the position t2 is usually written to the cache queue first, and the middleware layer also first detects the video frame at the position t2 in the cache queue. Since the video frame at the position t2 meets the tolerance range, the video frame at the position t2 is returned as the video frame that meets the seek request. It should be understood that if a plurality of video frames within the tolerance range are detected in the cache queue, a video frame closest to the second timeline position on the timeline is returned as the target video frame.

To further improve seek performance, in the present disclosure, a frame discarding strategy is configured for optimized implementation. In a conventional manner, the decoder directly discards non-reference frames preceding the timeline position indicated by the seek request. However, the direct discarding results in an error in calculating frame duration of video frames in a decoding queue, as the frame duration of the video frames is calculated based on presentation time stamps of two adjacent frames in the decoding queue. If some non-reference frames are discarded, the frame duration of the video frames may be incorrectly calculated.

In the present disclosure, a frame discarding strategy is optimized. Referring to FIG. 6, when performing decoding based on the seek request and the indicator signal, the decoder discards non-reference frames between an I-frame and a video frame corresponding to a prediction point (e.g., the position t2 in the foregoing embodiment). Since a quantity of video frames that need to be decoded is reduced, the computational load of decoding is reduced, thereby improving seek performance.

After returning a video frame, the application needs to update a time threshold, discards decoded video frames less than the time threshold, and writes the decoded video frames greater than or equal to the time threshold to the cache queue, thereby updating the cache queue. In the conventional manner, the cache queue is updated by calculating the time threshold based on quantities of past and future frames in the cache queue and presentation time stamps (PTSs) of the individual video frames in the cache queue. A large quantity of decoded video frames cannot enter the cache queue when the conventional manner is applied to a scenario of a forward seek.

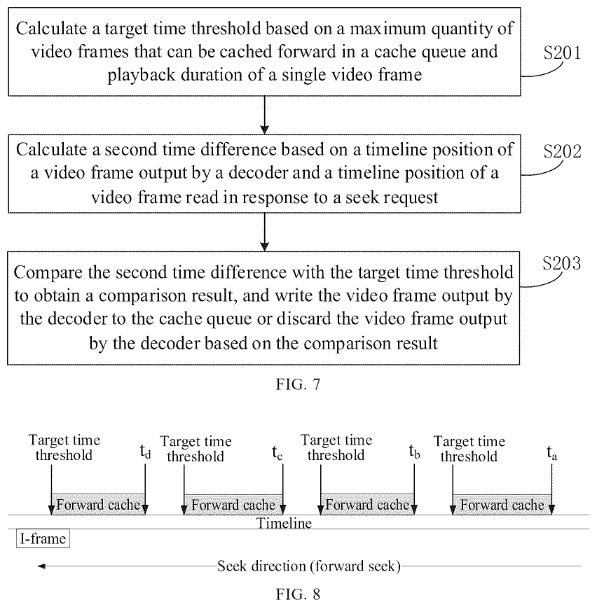

FIG. 7 is a flowchart of a video seek display processing method according to an embodiment of the present disclosure. Referring to FIG. 7, the method in this embodiment includes the following steps.
S201: Calculate a target time threshold based on a maximum quantity of video frames that can be cached forward in a cache queue and playback duration of a single video frame.

The length of the cache queue, the ratios of the forward cache and of the backward cache, etc., are usually preset. The maximum quantity of video frames that can be cached forward is determined based on the ratio of the forward cache to the entire length of the cache queue and the length of the cache queue. The maximum quantity of video frames that can be cached forward is then multiplied by frame duration of a single frame to obtain the target time threshold.

For example, assuming that the forward cache can cache up to 20 frames with playback duration of 33 milliseconds per frame, the target time threshold=20*0.033=0.66 seconds.
S202: Calculate a second time difference based on a timeline position of a video frame output by a decoder and a timeline position of a video frame read in response to a seek request.
S203: Compare the second time difference with the target time threshold to obtain a comparison result, and write the video frame output by the decoder to the cache queue or discard the video frame output by the decoder based on the comparison result.

If the comparison result indicates that the second time difference is less than the target time threshold, the decoded video frame output by the decoder is written to the cache queue. If the comparison result indicates that the second time difference is greater than or equal to the target time threshold, the decoded video frame output by the decoder is discarded.

In this embodiment, the target time threshold is calculated based on a quantity of cacheable video frames of the forward cache to update the cache queue, so that sufficient decoded video frames are provided in the forward cache to ensure as much as possible that the forward cache can fulfill a next forward seek.

In a specific embodiment, assuming that an application generates four seek requests in succession based on successive operations of a user and all the four seek requests are forward seeks, the four seeks return video frames at four time positions tₐ, t_{b}, tₑ, and t_{d} respectively. Each time a video frame is returned, the target time threshold is determined in the manner in the embodiment shown in FIG. 8, and the forward cache in the cache queue is updated.

Since a decoding anomaly may occur during a decoding process of raw data of a video, when a seek mode is a precise seek mode, it is determined that a precise frame may fail to be obtained after a seek operation is performed.

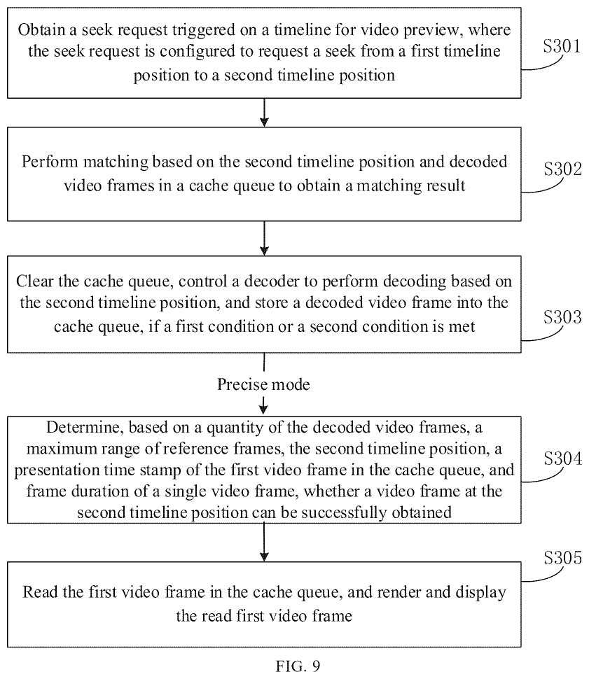

FIG. 9 is a flowchart of a video seek display processing method according to another embodiment of the present disclosure. Referring to FIG. 9, the method in this embodiment includes the following steps.
S301: Obtain a seek request triggered on a timeline for video preview, where the seek request is configured to request a seek from a first timeline position to a second timeline position.
S302: Perform matching based on the second timeline position and individual decoded video frames in a cache queue to obtain a matching result.
S303: Clear the cache queue, control a decoder to perform decoding based on the second timeline position, and store a decoded video frame into the cache queue, if a first condition or a second condition is met.

Steps S301 to S303 in this embodiment are similar to steps S101 to S103 in the embodiment shown in FIG. 2. Reference may be made to the detailed description of the embodiment shown in FIG. 2. For brevity, details are not described herein again.
S304: Determine, based on a quantity of the decoded video frames, a maximum range of reference frames, the second timeline position, a presentation time stamp of the first video frame in the cache queue, and frame duration of a single video frame, whether a video frame at the second timeline position can be successfully obtained.

When it is determined, based on the seek request, that a seek mode is a precise mode, it is determined whether a precise frame can be successfully obtained. For example, it is determined, based on the above-mentioned information, whether the following conditions are currently met.
Condition 1: A quantity of decoded video frames in a decoding queue is greater than the maximum range of reference frames.
Condition 2: A first time stamp is less than the presentation time stamp of the first video frame in the cache queue.
Condition 3: The time interval between the presentation time stamp of the first video frame in the cache queue and the first time stamp is less than the frame duration of a single video frame.
Condition 4: The presentation time stamp of the first video frame in the cache queue and the first time stamp are less than a preset time offset. The preset time offset is equal to a product of the maximum range of reference frames and the frame duration of a single video frame.

If all the above-mentioned condition 1 to condition 4 are met, it is determined that the video frame at the second timeline position cannot be successfully obtained to achieve a precise seek, and step S305 is performed. The reason that a precise frame corresponding to the seek request cannot be read may be that the maximum range of reference frames given by a video is incorrect, which in turn leads to an error in decoding.

It should be noted that in a precise seek mode, if any of the above-mentioned conditions is not met, it represents that a middleware layer of an application can achieve a precise seek.

S305: Read the first video frame in the cache queue, and render and display the read first video frame.

The middleware layer of the application reads decoded data of the first video frame of the cache queue and sends the decoded data to the business layer, and the business layer renders and displays the decoded data, thereby successfully achieving a picture seek.

This embodiment is essentially a fault tolerant processing mechanism for a precise seek scenario. In a scenario of a forward seek, when it is determined that a precise frame cannot be obtained, the video frame closest to the second timeline position in the cache queue is returned as a precise frame, thereby ensuring the smoothness of a video picture seek.

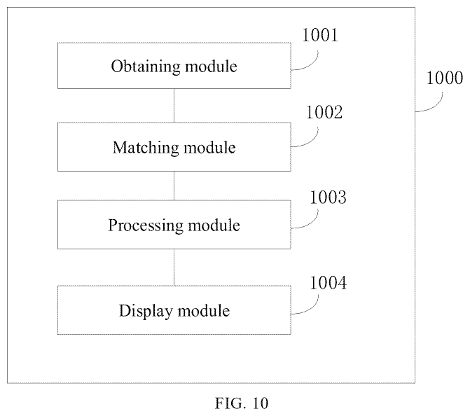

FIG. 10 is a structural diagram of a video seek display processing apparatus according to an embodiment of the present disclosure. Referring to FIG. 10, the apparatus 1000 provided in this embodiment includes:
an obtaining module 1001 configured to obtain a seek request triggered on a timeline for video preview, where the seek request is configured to request a seek from a first timeline position to a second timeline position;
a matching module 1002 configured to perform matching based on the second timeline position and individual decoded video frames in a cache queue to obtain a matching result;
a processing module 1003 configured to clear the cache queue, control a decoder to perform decoding based on the second timeline position, and store a decoded video frame into the cache queue, if a first condition or a second condition is met, or skip clearing the cache queue if a third condition or a fourth condition is met, where the first condition is that the seek request indicates a forward seek and the matching result indicates that the cache queue does not include a video frame at the second timeline position, the second condition is that a seek direction indicates a backward seek, the matching result indicates that the cache queue does not include the video frame at the second timeline position, and the video frame at the second timeline position and the cache queue do not belong to a same group of pictures, the third condition is that the cache queue includes the video frame at the second timeline position, and the fourth condition is that the seek direction indicates a backward seek, the matching result indicates that the cache queue does not include the video frame at the second timeline position, and the video frame at the second timeline position and the cache queue belong to a same group of pictures; and read from the cache queue, based on the condition that is met and a seek mode corresponding to the seek request, the video frame at the second timeline position or any video frame within a tolerance range for the second timeline position, and render and display the read video frame; and
a display module 1004 configured to display a corresponding video frame.

In some embodiments, the processing module 1003 is specifically configured to: read the video frame at the second timeline position from the cache queue, and render and display the read video frame, if the first condition or the second condition is met and the seek mode is a precise mode; read any video frame within the tolerance range for the second timeline position from the cache queue, and render and display the read video frame, if the first condition or the second condition is met and the seek mode is an imprecise mode; or read the video frame at the second timeline position from the cache queue, and render and display the read video frame, if the third condition or the fourth condition is met.

In some embodiments, before reading any video frame within the tolerance range for the second timeline position from the cache queue, and rendering and displaying the read video frame, the processing module 1003 is specifically configured to: calculate the tolerance range for the second timeline position.

In some embodiments, the processing module 1003 is specifically configured to: calculate a first time difference based on the second timeline position and a third timeline position, where the third timeline position is a timeline position of a video frame that is displayed by a previous seek request; and determine, in the seek direction, a time range that starts from the second timeline position and that has a distance from the second timeline position on the timeline meeting the first time difference as the tolerance range.

In some embodiments, the processing module 1003 is specifically configured to: control the decoder to discard, during the decoding, non-reference frames preceding the tolerance range on the timeline if the seek direction indicates a forward seek.

In some embodiments, the processing module 1003 is further configured to: calculate a target time threshold based on a maximum quantity of video frames that can be cached forward in the cache queue and playback duration of a single video frame; calculate a second time difference based on a timeline position of the video frame output by the decoder and a timeline position of the video frame read in response to the seek request; and compare the second time difference with the target time threshold to obtain a comparison result, and write the video frame output by the decoder to the cache queue or discard the video frame output by the decoder based on the comparison result.

In some embodiments, the processing module 1003 is further configured to: read a first video frame in the cache queue, and render and display the read first video frame if it is determined, based on a quantity of the decoded video frames, a maximum range of reference frames, the second timeline position, a presentation time stamp of the first video frame in the cache queue, and frame duration of a single video frame, that the video frame at the second timeline position cannot be successfully obtained.

The apparatus provided in this embodiment may be configured to implement the technical solution of any of the foregoing method embodiments. The implementation principle and technical effects thereof are similar, for which reference may be made to the detailed description of the foregoing method embodiments. For brevity, details are not described herein again.

For example, the present disclosure provides an electronic device, including: one or more processors; a memory; and one or more computer programs. The one or more computer programs are stored in the memory. The one or more processors, when executing the one or more computer programs, cause the electronic device to implement the video seek display processing methods of the foregoing embodiments.

For example, the present disclosure provides a chip system. The chip system is used in an electronic device including a memory and a sensor. The chip system includes a processor. The processor performs the video seek display processing methods of the foregoing embodiments.

For example, the present disclosure provides a computer-readable storage medium having a computer program stored thereon. The computer program, when executed by a processor, causes an electronic device to implement the video seek display processing methods of the foregoing embodiments.

For example, the present disclosure provides a computer program product. The computer program product, when executed by a computer, causes the computer to perform the video seek display processing methods of the foregoing embodiments.

In the foregoing embodiments, all or some functions may be implemented by software, hardware, or a combination of software and hardware. When implemented by software, all or some of the embodiments may be implemented in the form of the computer program product. The computer program product includes one or more computer instructions. When the computer program instructions are loaded and executed on the computer, all or some procedures or functions described in the embodiments of the present disclosure are generated. The computer may be a general-purpose computer, a dedicated computer, a computer network, or another programmable apparatus. The computer instructions may be stored in a computer-readable storage medium. The computer-readable storage medium may be any usable medium accessible by the computer, or may be a data storage device, for example, an integrated server or a data center, that includes one or more usable media. The usable medium may be a magnetic medium (for example, a floppy disk, a hard disk, or a magnetic tape), an optical medium (for example, a DVD), or a semiconductor medium (for example, a solid state disk (SSD)), etc.

It should be noted that the relational terms such as “first” and “second” herein are only used to distinguish one entity or operation from another, and do not necessarily require or imply that any actual relationship or sequence exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments described herein, but extends to the widest scope that complies with the principles and novelty disclosed in this specification.

1. A video seek display processing method, comprising:
obtaining a seek request triggered on a timeline for video preview, wherein the seek request is configured to request a seek from a first timeline position to a second timeline position;
performing matching based on the second timeline position and individual decoded video frames in a cache queue to obtain a matching result;
clearing the cache queue, controlling a decoder to perform decoding based on the second timeline position, and storing a decoded video frame into the cache queue, in response to a first condition or a second condition being met, or, skipping clearing the cache queue in response to a third condition or a fourth condition being met, wherein the first condition is that the seek request indicates a forward seek and the matching result indicates that the cache queue does not comprise a video frame at the second timeline position, the second condition is that a seek direction indicates a backward seek, the matching result indicates that the cache queue does not comprise the video frame at the second timeline position, and the video frame at the second timeline position and the cache queue do not belong to a same group of pictures, the third condition is that the cache queue comprises the video frame at the second timeline position, and the fourth condition is that the seek direction indicates a backward seek, the matching result indicates that the cache queue does not comprise the video frame at the second timeline position, and the video frame at the second timeline position and the cache queue belong to a same group of pictures; and
reading from the cache queue, based on the met condition and a seek mode corresponding to the seek request, the video frame at the second timeline position or any video frame within a tolerance range for the second timeline position, and rendering and displaying the read video frame.

2. The method of claim 1, wherein reading from the cache queue, based on the met condition and the seek mode corresponding to the seek request, the video frame at the second timeline position or any video frame within the tolerance range for the second timeline position, and rendering and displaying the read video frame comprises:
reading the video frame at the second timeline position from the cache queue, and rendering and displaying the read video frame, in response to the first condition or the second condition being met and the seek mode being a precise mode;
reading any video frame within the tolerance range for the second timeline position from the cache queue, and rendering and displaying the read video frame, in response to the first condition or the second condition being met and the seek mode being an imprecise mode; or
reading the video frame at the second timeline position from the cache queue, and rendering and displaying the read video frame, in response to the third condition or the fourth condition being met.

3. The method of claim 2, wherein, before reading any video frame within the tolerance range for the second timeline position from the cache queue, and rendering and displaying the read video frame, the method further comprises:
calculating the tolerance range for the second timeline position.

4. The method of claim 3, wherein calculating the tolerance range for the second timeline position comprises:
calculating a first time difference based on the second timeline position and a third timeline position, wherein the third timeline position is a timeline position of a video frame that is displayed in response to a previous seek request; and
determining, in the seek direction, a time range that starts from the second timeline position and that has a distance from the second timeline position on the timeline meeting the first time difference as the tolerance range.

5. The method of claim 1, wherein controlling the decoder to perform decoding based on the second timeline position comprises:
controlling the decoder to discard, during the decoding, non-reference frames preceding the tolerance range on the timeline in response to the seek direction indicating a forward seek.

6. The method of claim 1, further comprises:
calculating a target time threshold based on a maximum quantity of video frames that can be cached forward in the cache queue and playback duration of a single video frame;
calculating a second time difference based on a timeline position of the video frame output by the decoder and a timeline position of the video frame read in response to the seek request; and
comparing the second time difference with the target time threshold to obtain a comparison result, and writing the video frame output by the decoder to the cache queue or discarding the video frame output by the decoder based on the comparison result.

7. The method of claim 2, further comprises:
reading a first video frame in the cache queue, and rendering and displaying the read first video frame in response that it is determined, based on a quantity of the decoded video frames, a maximum range of reference frames, the second timeline position, a presentation time stamp of the first video frame in the cache queue, and frame duration of a single video frame, that the video frame at the second timeline position cannot be successfully obtained.

8. (canceled)

9. An electronic device, comprising a memory and a processor, wherein
the memory is configured to store computer program instructions; and
the processor is configured to execute the computer program instructions to cause the electronic device to:
obtain a seek request triggered on a timeline for video preview, wherein the seek request is configured to request a seek from a first timeline position to a second timeline position;
perform matching based on the second timeline position and individual decoded video frames in a cache queue to obtain a matching result;
clear the cache queue, controlling a decoder to perform decoding based on the second timeline position, and storing a decoded video frame into the cache queue, in response to a first condition or a second condition being met, or, skipping clearing the cache queue in response to a third condition or a fourth condition being met, wherein the first condition is that the seek request indicates a forward seek and the matching result indicates that the cache queue does not comprise a video frame at the second timeline position, the second condition is that a seek direction indicates a backward seek, the matching result indicates that the cache queue does not comprise the video frame at the second timeline position, and the video frame at the second timeline position and the cache queue do not belong to a same group of pictures, the third condition is that the cache queue comprises the video frame at the second timeline position, and the fourth condition is that the seek direction indicates a backward seek, the matching result indicates that the cache queue does not comprise the video frame at the second timeline position, and the video frame at the second timeline position and the cache queue belong to a same group of pictures; and
read from the cache queue, based on the met condition and a seek mode corresponding to the seek request, the video frame at the second timeline position or any video frame within a tolerance range for the second timeline position, and rendering and displaying the read video frame.

10. A non-transitory readable storage medium having computer program instructions stored thereon,
which, when executed by at least one processor of an electronic device, cause the electronic device to:
obtain a seek request triggered on a timeline for video preview, wherein the seek request is configured to request a seek from a first timeline position to a second timeline position;
perform matching based on the second timeline position and individual decoded video frames in a cache queue to obtain a matching result;
clear the cache queue, controlling a decoder to perform decoding based on the second timeline position, and storing a decoded video frame into the cache queue, in response to a first condition or a second condition being met, or, skipping clearing the cache queue in response to a third condition or a fourth condition being met, wherein the first condition is that the seek request indicates a forward seek and the matching result indicates that the cache queue does not comprise a video frame at the second timeline position, the second condition is that a seek direction indicates a backward seek, the matching result indicates that the cache queue does not comprise the video frame at the second timeline position, and the video frame at the second timeline position and the cache queue do not belong to a same group of pictures, the third condition is that the cache queue comprises the video frame at the second timeline position, and the fourth condition is that the seek direction indicates a backward seek, the matching result indicates that the cache queue does not comprise the video frame at the second timeline position, and the video frame at the second timeline position and the cache queue belong to a same group of pictures; and
read from the cache queue, based on the met condition and a seek mode corresponding to the seek request, the video frame at the second timeline position or any video frame within a tolerance range for the second timeline position, and rendering and displaying the read video frame.

11. (canceled)

12. The electronic device of claim 9, wherein the processor configured to read from the cache queue, based on the met condition and the seek mode corresponding to the seek request, the video frame at the second timeline position or any video frame within the tolerance range for the second timeline position, and render and display the read video frame is further configured to execute the computer program instructions to cause the electronic device to:
read the video frame at the second timeline position from the cache queue, and render and display the read video frame, in response to the first condition or the second condition being met and the seek mode being a precise mode;
read any video frame within the tolerance range for the second timeline position from the cache queue, and render and display the read video frame, in response to the first condition or the second condition being met and the seek mode being an imprecise mode; or
read the video frame at the second timeline position from the cache queue, and render and display the read video frame, in response to the third condition or the fourth condition being met.

13. The electronic device of claim 12, wherein, before reading any video frame within the tolerance range for the second timeline position from the cache queue, and rendering and displaying the read video frame, the processor is further configured to execute the computer program instructions to cause the electronic device to:
calculate the tolerance range for the second timeline position.

14. The electronic device of claim 13, wherein the processer configured to calculate the tolerance range for the second timeline position is further configured to execute the computer program instructions to cause the electronic device to:
calculate a first time difference based on the second timeline position and a third timeline position, wherein the third timeline position is a timeline position of a video frame that is displayed in response to a previous seek request; and
determine, in the seek direction, a time range that starts from the second timeline position and that has a distance from the second timeline position on the timeline meeting the first time difference as the tolerance range.

15. The electronic device of claim 9, wherein the processer configured to control the decoder to perform decoding based on the second timeline position is further configured to execute the computer program instructions to cause the electronic device to:
control the decoder to discard, during the decoding, non-reference frames preceding the tolerance range on the timeline in response to the seek direction indicating a forward seek.

16. The electronic device of claim 9, wherein the processor is further configured to execute the instructions to cause the electronic device to:
calculate a target time threshold based on a maximum quantity of video frames that can be cached forward in the cache queue and playback duration of a single video frame;
calculate a second time difference based on a timeline position of the video frame output by the decoder and a timeline position of the video frame read in response to the seek request; and
compare the second time difference with the target time threshold to obtain a comparison result, and writing the video frame output by the decoder to the cache queue or discarding the video frame output by the decoder based on the comparison result.

17. The electronic device of claim 12, wherein the processor is further configured to execute the instructions to cause the electronic device to:
read a first video frame in the cache queue, and render and display the read first video frame in response that it is determined, based on a quantity of the decoded video frames, a maximum range of reference frames, the second timeline position, a presentation time stamp of the first video frame in the cache queue, and frame duration of a single video frame, that the video frame at the second timeline position cannot be successfully obtained.

18. The non-transitory readable storage medium of claim 10, wherein the computer program instructions configured to read from the cache queue, based on the met condition and the seek mode corresponding to the seek request, the video frame at the second timeline position or any video frame within the tolerance range for the second timeline position, and render and display the read video frame further cause the electronic device to:
read the video frame at the second timeline position from the cache queue, and render and display the read video frame, in response to the first condition or the second condition being met and the seek mode being a precise mode;
read any video frame within the tolerance range for the second timeline position from the cache queue, and render and display the read video frame, in response to the first condition or the second condition being met and the seek mode being an imprecise mode; or
read the video frame at the second timeline position from the cache queue, and render and display the read video frame, in response to the third condition or the fourth condition being met.

19. The non-transitory readable storage medium of claim 18, wherein, before reading any video frame within the tolerance range for the second timeline position from the cache queue, and rendering and displaying the read video frame, the computer program instructions further cause the electronic device to:
calculate the tolerance range for the second timeline position.

20. The non-transitory readable storage medium of claim 19, wherein the computer program instructions configured to calculate the tolerance range for the second timeline position further cause the electronic device to:
calculate a first time difference based on the second timeline position and a third timeline position, wherein the third timeline position is a timeline position of a video frame that is displayed in response to a previous seek request; and
determine, in the seek direction, a time range that starts from the second timeline position and that has a distance from the second timeline position on the timeline meeting the first time difference as the tolerance range.

21. The non-transitory readable storage medium of claim 10, wherein the computer program instructions configured to control the decoder to perform decoding based on the second timeline position further cause the electronic device to:
control the decoder to discard, during the decoding, non-reference frames preceding the tolerance range on the timeline in response to the seek direction indicating a forward seek.

22. The non-transitory readable storage medium of claim 10, wherein the computer program instructions further cause the electronic device to:
calculate a target time threshold based on a maximum quantity of video frames that can be cached forward in the cache queue and playback duration of a single video frame;
calculate a second time difference based on a timeline position of the video frame output by the decoder and a timeline position of the video frame read in response to the seek request; and
compare the second time difference with the target time threshold to obtain a comparison result, and writing the video frame output by the decoder to the cache queue or discarding the video frame output by the decoder based on the comparison result.
